(19) United States
(12) Patent Application Publication
(10) Pub. No.: US 2005/0088567 A1
(43) Pub. Date: Apr. 28, 2005

(54) Apparatus and method for sensing illumination by using image sensor

(76) Inventor: Jae-Hyup Kim, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,417

(22) Filed: Dec. 31, 2003

(30) Foreign Application Priority Data
Oct. 27, 2003 (KR) 2003-74995

(51) Int. Cl. H04N 9/68; H04N 5/222

(52) U.S. Cl. 348/370; 348/237

(57) ABSTRACT

Disclosed is an apparatus and method for sensing illumination by using an image sensor, in which a camera image sensor embedded in a wireless terminal is used to sense a peripheral illumination without using a conventional photo sensor. The apparatus includes: an image sensor for scanning an image with reference to each gain of Red, Green and Blue (RGB) to generate image data; a control unit for generating a light-emitting control signal or a light-emitting on/off signal with reference to the image data and the gain; and a light-emitting unit for adjusting an illumination of an internal light-emitting device or turning on/off the light-emitting device according to the light-emitting control signal or the light-emitting on/off signal.

### FIELD OF THE INVENTION

The present invention relates to an apparatus and method for sensing illumination by using an image sensor; and, more particularly, to an apparatus and method for sensing illumination using an image sensor, in which a camera image sensor embedded in a wireless terminal is used to sense a peripheral illumination without using a conventional photo sensor.

### DESCRIPTION OF THE PRIOR ART

Recently, there is a tendency to apply many camera functions to hand-held terminals and manufacturing industry fields provide the corresponding functions little by little because the camera functions are almost set to default values.

FIG. 1 is a block diagram showing a conventional illumination sensing apparatus using a photo sensor of a wireless terminal.

Referring to FIG. 1, the conventional illumination sensing apparatus using the photo sensor of the terminal includes a control unit 11 and a camera photodiode 12. The control unit generates a control signal used for sensing an illumination adjacent to a terminal, so that an illumination (e.g., a backlight of a liquid crystal display LCD for the terminal, a light-emitting diode LED of a strobo) can be controlled (on/off) at a key input or a call reception. The camera photodiode 12 senses the illumination adjacent to the terminal according to the control signal to transmit the sensed result to the control unit 11.

Through the above illumination sensing operation, various operations are performed for adjusting a backlight lightness of the LCD for the terminal or for turning on/off the LED of the strobo.

However, since a photo sensor chip should be installed within the terminal, the conventional illustration sensing apparatus of the wireless terminal using the photo sensor has a drawback in that a circuit design is complicated due to a necessity for an additional interface design. Additionally, since the illumination sensing operation using the photo diode 12 is generally performed with reference to a fixed lightness, the conventional illumination sensing apparatus has a drawback in that it cannot be adapted to changes in an environmental temperature, and the like.

### SUMMARY OF THE INVENTION

It is, therefore, an object of the present invention to provide an apparatus and method for sensing illumination by using an image sensor, which is capable of adaptable to changes in an environmental temperature and making it easy to design a circuit since a photo sensor is not used and thus its related interface circuit is not required.

In accordance with one aspect of the present invention, there is provided an illumination sensing apparatus for use in a mobile terminal, including: an image sensor for scanning an image with reference to each gain of Red, Green and Blue (RGB) to generate image data; a control unit for generating a light-emitting control signal or a light-emitting on/off signal with reference to the image data and the gain; and a light-emitting unit for adjusting an illumination of an internal light-emitting device or turning on/off the light-emitting device according to the light-emitting control signal or the light-emitting on/off signal.

In accordance with another aspect of the present invention, there is provided an illumination sensing method in a mobile terminal, including the steps of: a) activating a camera function of the mobile terminal; b) scanning an image with reference to each gain of RGB to generate image data, thereby obtaining the image data and the gain; c) comparing the gain with a magnitude of a luminance component of the image data; and d) adjusting a brightness of a light-emitting device according to the comparative result of the gain and the magnitude of the luminance component of the image data, and then returning to the step of activating the camera function of the mobile terminal.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram of a conventional illumination sensing apparatus using a photo sensor of a wireless terminal;.

FIG. 2 is a block diagram of an illustration sensing apparatus using an image sensor in accordance with a preferred embodiment of the present invention;

FIG. 3 is an operational flowchart illustrating an illumination sensing method using an image sensor in accordance with a preferred embodiment of the present invention;

FIG. 4A is a graph illustrating a sensitivity of an image sensor in accordance with a preferred embodiment of the present invention;

FIG. 4B is a graph illustrating a sensitivity of a conventional photo sensor used for sensing an illumination; and

FIG. 5 is a block diagram of an image sensor installed within an illumination sensing apparatus in accordance with an embodiment of the present invention.

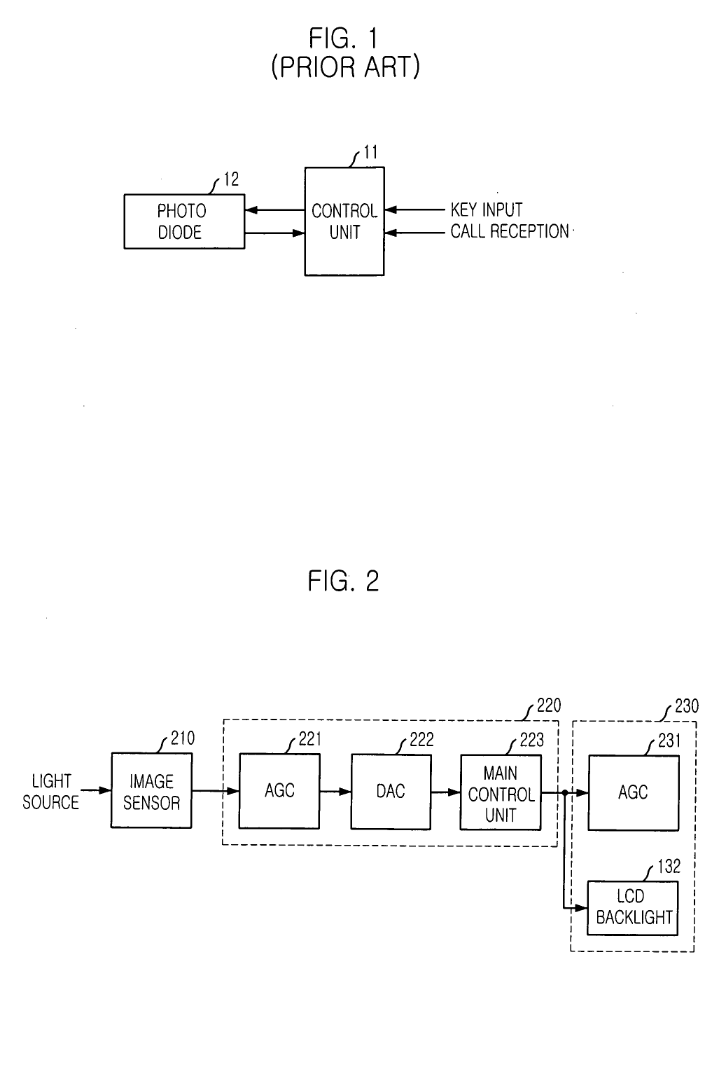

### DETAILED DESCRIPTION OF THE PREFERRED EMBODIMENTS

Reference will now be made in detail to the preferred embodiments of the present invention, examples of which are illustrated in the accompanying drawings.

Generally, wireless terminal with a built-in camera includes a portable phone, s smart phone, a portable digital assistant (PDA), and the like, but they are referred to as a “mobile terminal” throughout this specification.

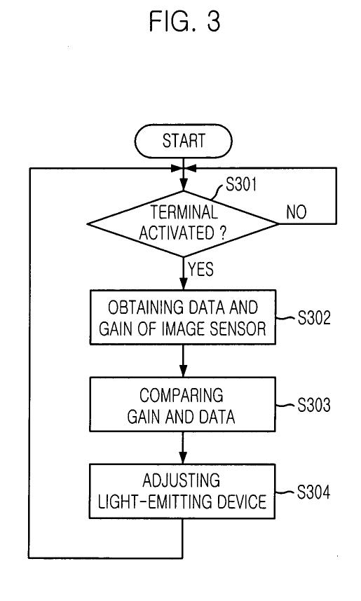

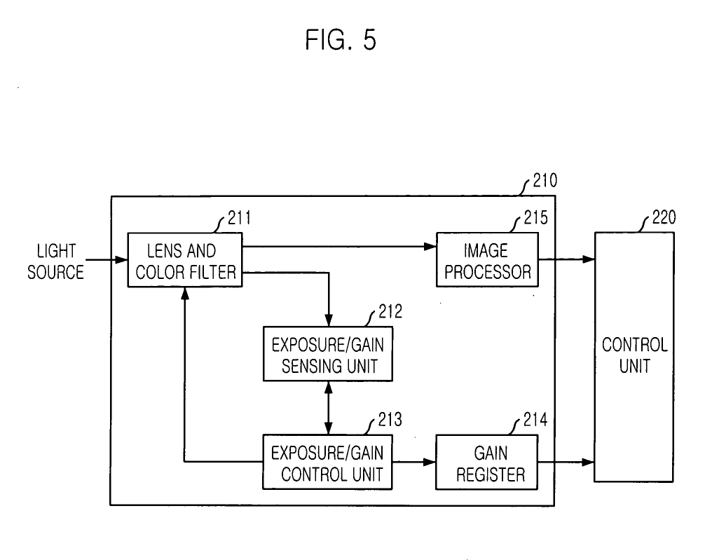

FIG. 2 is a block diagram of an illustration sensing apparatus using an image sensor in accordance with an embodiment of the present invention, and FIG. 5 is a block diagram of an image sensor installed within the illumination sensing apparatus in accordance with an embodiment of the present invention. Referring to FIG. 2, the illustration sensing apparatus in accordance with the present invention includes an image sensor 210, a control unit 220 and a light-emitting unit 230.

The image sensor 210 scans an image with reference to each gain for Red, Green and Blue (RGB) to generate image data, and outputs the image data and the gains to the control unit 220, which will be described. Herein, the image sensor 210 will be described below in detail with reference to FIG. 5.

A lens and color filter 211 installed within the image sensor 210 is an analog processing unit. The lens and color filter 211 receives a light source and obtains an image through a filtering process.

Further, an exposure/gain sensing unit 212 installed within the image sensor 210 senses an exposure value and a gain value of the image obtained through the lens and color filter 211.

In the meantime, an exposure/gain control unit 213 installed within the image sensor 210 generates an exposure/gain control signal for appropriately controlling exposure/gain using the exposure value and the gain value inputted from the exposure/gain sensing unit 212, and outputs the exposure/gain control signal to the lens and color filter 211.

Further, a gain register 214 installed within the image sensor 210 stores the gain value, which is inputted through the exposure/gain control unit 213, as the respective gain of RGB.

In the meantime, an image processing unit 215 installed within the image sensor 210 processes the image obtained through the lens and color filter 211 into digital image data.

Further, the control unit 220 receives the image data and the gain from the image sensor 210 and generates a light-emission control signal or a light-emission on/off signal with reference to the image data and the gain. Herein, the control unit 220 will be described below in detail.

An automatic gain controller (AGC) 221 installed within the control unit 220 receives and amplifies the image data from the image sensor 210 and then outputs the amplified image data as the resultant data to a digital-to-analogue converter (DAC) 222, which will be described later.

Further, the DAC 222 installed within the control unit 220 receives the amplified image data from the AGC 221 and converts the amplified image data (analog data) into digital image data (digital data).

In the meantime, a main control unit 223 installed within the control unit 220 receives the gain and the digital image data from the image sensor 210 and the DAC 222 and compares the gain with a magnitude of a luminance component of the digital image data. Then, the main control unit 223 generates the light-emitting control signal or the light-emitting on/off signal according to the comparative result and outputs the light-emitting control signal or the light-emitting on/off signal to the light-emitting unit 230, which will be described later.

Further, the light-emitting unit 230 adjusts the illumination of an internal light-emitting device depending on the light-emitting control signal or the light-emitting on/off signal outputted from the control unit 220, or turns on/off the light-emitting device. Herein, the light-emitting device 230 will be described below in detail.

When a camera module is used, a strobo LED 231 installed within the light-emitting unit 230 performs a strobo on/off operation according to the light-emitting on/off signal outputted from the control 220.

Further, a LCD backlight 232 installed within the light-emitting unit 230 adjusts a backlight lightness according to the light-emitting control signal outputted from the control unit 220.

Herein, an operation of the illumination sensing apparatus in accordance with the present invention will be described below in detail.

First, if a user opens the mobile terminal, a camera function is activated.

Then, the image sensor 210 scans the image with reference to each gain of RGB to generate the image data and outputs the image data and the gain to the control unit 220. At this time, if the usage environment is dark, the gain is set to a considerably high value, and if it is bright, the gain is set to a relatively low value.

Then, the control unit 220 receives the image data and the gain from the image sensor 210.

At this time, in case the usage environment is dark, even though the gain is set to the higher value, the inputted luminance component of the image data will have the lower value. That is, if the luminance component of the image data has the lower value in spite of the low value of the gain, the control unit 220 recognizes that the usage environment is dark and thus generates the light-emitting control signal for lightening the brightness of the light-emitting unit 230 or the light-emitting on/off signal for turning on the LED installed in the strobo, a keypad, and the like.

In the meanwhile, if the usage environment is bright while the gain is set to the lower value, the inputted luminance component of the image data will have the higher value. That is, if the luminance component of the image data has the higher value in spite of the low value of the gain, the control unit 220 recognizes that the usage environment is bright and thus generates the light-emitting control signal for darkening the brightness of the light-emitting unit 230 or the light-emitting on/off signal for turning off the LED installed in the strobo, the keypad, and the like.

Here, the brightness of the light-emitting unit 230 can also be set stepwise according to a mutual relation between the gain and the luminance component value of the image data.

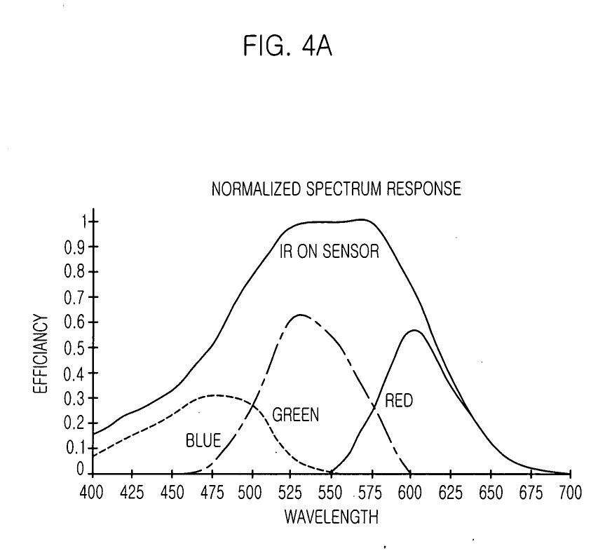

FIG. 3 is an operational flowchart illustrating an illumination sensing method using the image sensor in accordance with an embodiment of the present invention. An illumination sensing method in accordance with an embodiment of the present invention will be described below in detail with reference to FIG. 3.

First, the camera function of the terminal is activated in predetermined manner, for example, by opening the mobile terminal at step S301.

Then, the image sensor 210 scans the image with reference to each gain of RGB to generate the image data, and the control unit 220 receives the image data and the gain from the image sensor 210 at step S302.

Next, the control unit 220 compares the gain with the magnitude of the luminance component of the image data at step S303.

Then, the light-emitting device of the light-emitting unit 230 is adjusted in brightness depending on the comparative result of the gain and the magnitude of the luminance component of the image data, and then the process returns to the step S301 of activating the camera function of the terminal at step S304.

In other words, in case the usage environment is dark, even though the gain is set to the higher value, the inputted luminance component of the image data will have the lower value. That is, even though the gain has the higher value in spite of the luminance component of the low value, the control unit 220 recognizes that the usage environment is dark and thus generates the light-emitting signal for lightening the brightness of the light-emitting unit 230 or the light-emitting on/off signal for turning on the LED installed in the strobo, the keypad, and the like.

In the meantime, in case the usage environment is bright, even though the gain is set to the lower value, the inputted luminance component of the image data will have the higher value. That is, if the luminance component of the image data has the higher value in spite of the gain of the low value, the control unit 220 recognizes that the usage environment is bright and thus generates the light-emitting control signal for darkening the brightness of the light-emitting unit 230 or the light-emitting on/off signal for turning off the LED installed in the strobo, the keypad, and the like.

Herein, the brightness of the light-emitting unit 230 can be stepwise set in a manufacturing procedure depending on the mutual relation between the gain and the luminance component value of the image data.

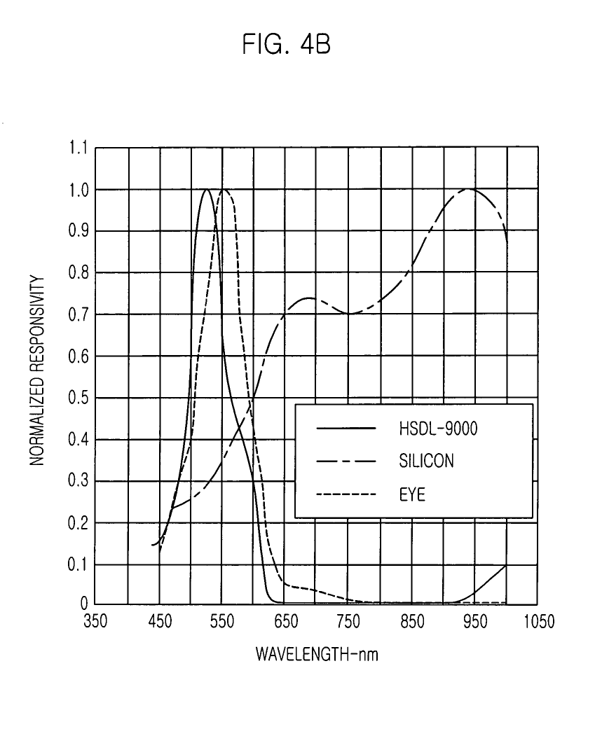

FIG. 4A is a graph illustrating a sensitivity of the image sensor 210 in accordance with an embodiment of the present invention, and FIG. 4B is a graph illustrating a sensitivity of the conventional photo sensor for sensing the illumination. Referring to FIGS. 4A and 4B, it can be appreciated that both the image sensor and the photo sensor have almost similar sensitivities in a visible ray region.

As described above, the illumination sensing apparatus in accordance with the present invention is adaptable for the changes in an environmental temperature and makes it easy to design a circuit since a photo sensor is not used and thus its related interface circuit is not required.

While the present invention has been described with respect to the particular embodiments, it will be apparent to those skilled in the art that various changes and modifications may be made without departing from the scope of the invention as defined in the following claims.

1. An illumination sensing apparatus for use in a mobile terminal, comprising:
an image sensor for scanning an image with reference to each gain of Red, Green and Blue (RGB) to generate image data;
a control means for generating a light-emitting control signal or a light-emitting on/off signal with reference to the image data and the gain; and
a light-emitting means for adjusting an illumination of an internal light-emitting device or turning on/off the light-emitting device according to the light-emitting control signal or the light-emitting on/off signal.

2. The illumination sensing apparatus as recited in claim 1, wherein the control means includes a main control unit for comparing the gain with a magnitude of a luminance component of the image data, and for generating the light-emitting control signal or the light-emitting on/off signal according to the comparative result.

3. The illumination sensing apparatus as recited in claim 1, wherein the light-emitting control signal is a signal for adjusting brightness stepwise according to the gain and the magnitude of the luminance component of the image data.

4. The illumination sensing apparatus as recited in claim 1, wherein the light-emitting means includes:
a strobo light-emitting diode (LED) for performing a strobo on/off operation in a use of a camera module according to the light-emitting on/off signal; and
an LCD backlight for adjusting a backlight brightness according to the light-emitting control signal.

5. The illumination sensing apparatus as recited in claim 3, wherein the light-emitting means includes:
a strobo light-emitting diode (LED) for performing the strobo on/off operation in a use of a camera module according to the light-emitting on/off signal; and
an LCD backlight for adjusting a backlight brightness according to the light-emitting control signal.

6. An illumination sensing method in a mobile terminal, comprising the steps of:
a) activating a camera function of the mobile terminal;
b) scanning an image with reference to each gain of RGB to generate image data, thereby obtaining the image data and the gain;
c) comparing the gain with a magnitude of a luminance component of the image data; and
d) adjusting a brightness of a light-emitting device according to the comparative result of the gain and the magnitude of the luminance component of the image data, and then returning to the step of activating the camera function of the mobile terminal.

7. The illumination sensing method as recited in claim 6, wherein in the step d), a reference gain and a reference luminance component are set, and if the luminance component of the image data has a lower value than the reference luminance component while the gain has a higher value than the reference gain, a light-emitting control signal is generated for lightening the brightness of the light-emitting device.

8. The illumination sensing method as recited in claim 6, wherein in the step d), the reference gain and the reference luminance component are set, and if the luminance component of the image data has a higher value than the reference luminance component while the gain has a lower value than the reference gain, a light-emitting control signal is generated for darkening the brightness of the light-emitting device.

9. The illumination sensing method as recited in claim 6, wherein in the step d), the reference gain and the reference luminance component are set, and if the luminance component of the image data has the lower value than the reference luminance component while the gain has the higher value than the reference gain, a light-emitting on/off signal is generated for turning on the light-emitting device.

10. The illumination sensing method as recited in claim 6, wherein in the step d), the reference gain and the reference luminance component are set, and if the luminance component of the image data has the higher value than the reference luminance component while the gain has the lower value than the reference gain, a light-emitting on/off signal is generated for turning off the light-emitting device.
